(19) United States
(12) Patent Application Publication
(10) Pub. No.: US 2008/0315767 A1
(43) Pub. Date: Dec. 25, 2008

(54) PLASMA DISPLAY PANEL

(76) Inventors: Yoshimi KAWANAMI, Miyazaki (JP); Nobuyuki Hori, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/038,825

(22) Filed: Feb. 28, 2008

(30) Foreign Application Priority Data
Jun. 19, 2007 (JP) 2007-161115

(51) Int. Cl. H01J 17/49

(52) U.S. Cl. 313/584

(57) ABSTRACT

A transmission-type PDP having high emission efficiency is provided. This PDP comprises: a first substrate structure (rear unit) having a pair of display electrodes; a second substrate structure (front unit) having an address electrode and a display surface; a barrier rib being translucent; and a phosphor layer. And, at the rear unit side, a specular reflecting film having light reflectivity toward the front side is provided to a first substrate. For example, the specular reflecting film is adhered to the rear side of the first glass substrate. The emission from the phosphor layer is reflected by the specular reflecting film and transmitted by the barrier rib, thereby utilizing the emission as luminance.

### CROSS-REFERENCE TO RELATED APPLICATION

The present application claims priority from Japanese Patent Application No. JP 2007-161115 filed on Jun. 19, 2007, the content of which is hereby incorporated by reference into this application.

### TECHNICAL FIELD OF THE INVENTION

The present invention relates to a plasma display panel (PDP) and a display device thereof (plasma display devices: PDP devices). More particularly, the present invention relates to a transmission-type PDP.

### BACKGROUND OF THE INVENTION

For an AC (alternating current drive) type PDP device, as a way of using the light emission from phosphors by discharge, a transmission type has been considered in the early stages. However, since this type has been regarded to be insufficient in terms of the light emission efficiency, the structure of a current reflection type has become mainstream. Note that, here, the transmission type means a type whose front unit side having a display surface has an address electrode (denoted by A), a phosphor, and so forth arranged thereto, and whose rear unit side has a display electrodes (denoted by X, Y) arranged thereto. The reflection type means the opposite of the transmission type. The display electrode is a sustain electrode (denoted by X), a scanning electrode (denoted by Y), and the like used for discharge in a display (sustain discharge) period.

However, also in recent years, some studies on the modification of the transmission-type PDP have been made.

As for a three-electrode/transmission-type PDP, there are those disclosed in Japanese Patent Application Laid-Open Publication No. 2004-356063 and Japanese Patent Application Laid-Open Publication No. 2004-14372. As for a four-electrode/transmission-type PDP, there is the one disclosed in Japanese Patent No. 3437596.

### SUMMARY OF THE INVENTION

With respect to the conventional transmission-type PDP, there has been room for consideration/improvement in various points such as emission efficiency. Particularly, it is necessary to effectively utilize the emission from phosphors.

An object of the present invention is to provide a transmission-type PDP having high emission efficiency in a technique of the PDP.

The typical ones of the inventions disclosed in this application will be briefly described as follows. To achieve the object, the present invention is a technique based on the transmission-type PDP, and is characterized to have the following configurations. First, the present PDP (transmission-type PDP) is configured such that a first substrate structure (rear unit) including a display electrode pair (X, Y) is arranged to a rear surface side, and a second substrate structure (surface unit) including an address electrode (A) and having a display surface is arranged to a front surface side, and between the first and second substrate structures, there are a discharge space divided by barrier ribs and encapsulating a discharge gas and phosphors (phosphor layers) formed at least on side surfaces of the barrier rib between the barrier ribs. There is no particular restriction on the type and the shape of each electrode. The barrier ribs are, for example, stripe-shaped or box-shaped or the like. For purpose of description, for the present PDP, the front unit side is referred to as a second substrate structure, and the rear unit side is referred to as a first substrate structure.

The present PDP is configured to comprise, as its main features, as well as barrier ribs being translucent as first means, a film (layer) or a member (referred to as a specular reflecting film) as second means having a property of specularly reflecting the discharge emission toward the front surface side (i.e., specular reflectivity in a third direction orthogonal to a panel surface). By the first and second means, the discharge emission (light emission (visible light of R, G, B) from the phosphors by the discharge (sustain discharge) in the display cell) is utilized as luminance without wasting as possible, thereby increasing the luminance efficiency. The barrier rib transmits at least a part of the discharge emission including the reflected light by the specular reflecting film. Among the discharge emissions, the light toward the rear direction is reflected by the specular reflecting film of the rear unit side, and is particularly transmitted by the barrier rib, and passes through the display surface of the front unit. Such a configuration will be described in detail as follows.

(1) The present PDP and a PDP module are configured to provide, for example, a specular reflecting layer made of aluminum (Al), chrome (Cr) and the like on the rear surface side (outside) of the first glass substrate of the rear unit. The specular reflecting film is arranged in an area including at least a center vicinity of the display cell. Particularly, the specular reflecting film should be a solid layer and the like corresponding to the entire surface of the panel display area (screen by a display cell group).

Further, for example, the configuration may be such that the rear surface of the first glass substrate has the specular reflecting film adhered thereto made of an Al sheet and the like by an adhesive, for example, on the entire surface corresponding to the display area. Further, the configuration is such that the fixation of the PDP with a chassis is performed by the adhesive such as a double-sided tape, for example, by a peripheral part of the panel. It is preferable to provide an air space between the specular reflecting film and the chassis surface.

Furthermore, for example, the configuration may be such that a heat transfer member such as a carbon sheet is fixed together in addition to the specular reflecting film. Such a configuration, for example, may include a configuration having a member for fixing a heat radiating member to the rear surface side of the specular reflecting film or a member for coating the heat transfer member by the specular reflecting film (Al resin and the like) to the rear surface of the first glass substrate.

Moreover, for example, the configuration may be such that the rear surface side of the first glass substrate has the specular reflecting film fixed (formed) thereto, and further, the rear surface side of the specular reflecting film and the chassis surface are adhered by an adhesive such as a double-sided tape.

(2) The present PDP has a configuration such that, for example, the front surface side (inside of the rear unit) of the first glass substrate of the rear unit has a specular reflecting film made of Al, Cr, and the like formed thereto at a position below the forming surface of the display electrode. For example, to the front surface of the first glass substrate, the specular reflecting film is formed, for example, on the entire surface corresponding to the panel display area, and the display electrode and the first dielectric layer and so forth are formed thereon.

Further, for example, the configuration is set such that the first glass substrate has a specular reflecting layer formed thereto in common with a part of a layer forming the display electrode. The display electrode is made of a three-layer structure of, for example, Cr, Cu (copper), and Cr, and the specular reflecting film is formed in the area of the upper layer of Cr or the lower layer of Cr, for example, in the entire surface (solid layer) corresponding to the panel display area.

The effects obtained by typical aspects of the present invention will be briefly described below. According to the present invention, in the technology of PDP, a transmission-type PDP having high emission efficiency can be provided.

### BRIEF DESCRIPTIONS OF THE DRAWINGS

FIG. 1 is a diagram showing a basic schematic configuration of a PDP in a PDP device (PDP module) according to the present invention;

FIG. 2 is a diagram showing a schematic structure in a lateral cross section (x-z plane) of the PDP device which is a first embodiment (configuration 1A) of the present invention;

FIG. 3 is a diagram showing a detailed structure of a part in the lateral cross section (x-z plane) of the PDP device which is the first embodiment of the present invention;

FIG. 4 is a diagram showing a part (corresponding to a display cell) of a structure in the lateral cross section (x-z plane) of the PDP in the PDP device which is the first embodiment of the present invention;

FIG. 5 is a diagram showing a schematic structure of a part (corresponding to a display cell) of a plane viewed from a front surface side of the PDP in the PDP device which is the first embodiment of the present invention;

FIG. 6 is a diagram showing a part of a detailed structure of a lateral cross section (x-z plane) of a PDP device which is a second embodiment (configuration 1Ba) of the present invention;

FIG. 7 is a diagram showing a part of a detailed structure of a lateral cross section (x-z plane) of a PDP device which is a third embodiment (configuration 1Bb) of the present invention;

FIG. 8 is a diagram showing a schematic structure of a lateral cross section (x-z plane) of a PDP device which is a fourth embodiment (configuration 1C) of the present invention;

FIG. 9 is a diagram showing a structure of a part (corresponding to the display cell) of a lateral cross section (x-z plane) of a PDP in a PDP device which is a fifth embodiment (configuration 2A) of the present invention;

FIG. 10 is a diagram showing a part of a detailed structure of a lateral cross section (x-z plane) of a rear unit of a PDP in a PDP device which is a sixth embodiment (configuration 2Ba) of the present invention;

FIG. 11 is a diagram showing a part of a detailed structure of a lateral cross section (x-z plane) of a rear unit of a PDP in a PDP device which is a seventh embodiment (configuration 2Bb) of the present invention;

FIG. 12A is a diagram showing an emission profile from a front surface side of a panel by the presence or absence of a mirror of a rear surface side in a PDP of a conventional art example, and showing a case where, corresponding to the reflection-type PDP, a mirror is arranged on the rear surface side; and

FIG. 12B is a diagram showing an emission profile from the front surface side of a panel by the presence or absence of the mirror of a rear surface side in the PDP of the conventional art example, and showing a case where, corresponding to a transmission-type PDP (reversal arrangement of the reflection-type PDP), the mirror is arranged on the rear surface side in association with the PDP device of the embodiment of the present invention.

### DESCRIPTIONS OF THE PREFERRED EMBODIMENTS

Hereinafter, first to seventh embodiments of the present invention will be described in detail with reference to the accompanying drawings. Note that components having the same function are denoted by the same reference symbols throughout the drawings for describing the first to seventh embodiment, and the repetitive description thereof will be omitted.

### First Embodiment

### Configuration 1A

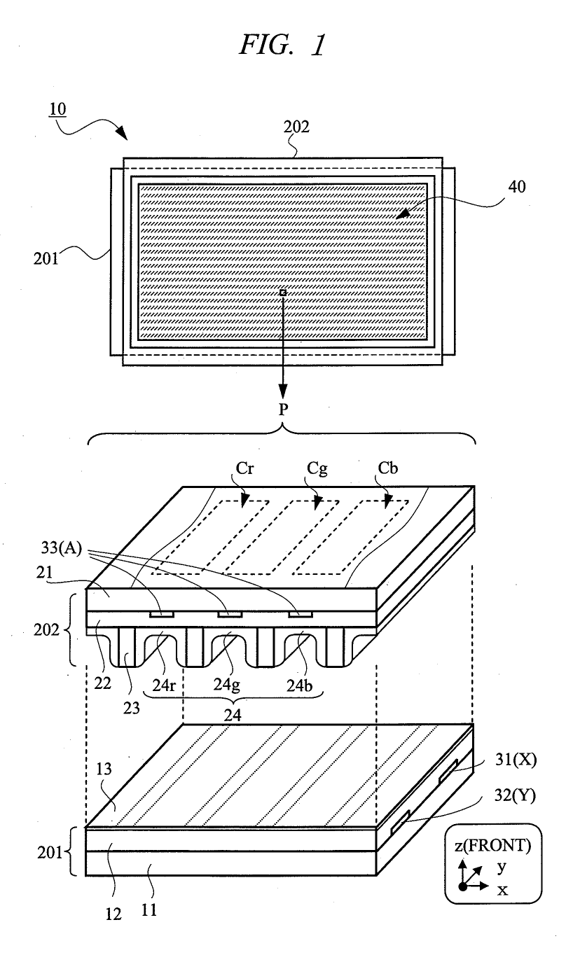

With reference to FIG. 1 to FIG. 5, a PDP device (PDP module 100) of a first embodiment (Configuration 1A) of the present invention will be described. A PDP 10 of the present PDP module 100 has a configuration in which a first glass substrate 11 of a rear unit 201 has a specular reflecting film 60 fixed thereto on a rear surface side (outside) thereof.

<Basic Configuration>

First, in FIG. 1, the PDP 10 serving as a basic structure of the first to seventh embodiments will be descried, and the detailed features thereof will be described later. The PDP 10 of FIG. 1 is a case of an AC-type/surface-discharge and three-electrode (X, Y, A) configuration based on the transmission-type PDP. For purposes of illustration, the PDP 10 has a first direction (x), a second direction (y), and a third direction (z). For a display area (screen) 40 of the PDP 10, the reference symbol x denotes a direction of a horizontally extending display row, the reference symbol y denotes a direction of a vertically extending display column, and the reference symbol z denotes a front-rear direction perpendicular to the panel surface, and the upper side is the front surface (display surface) side, and the lower side is the rear surface side.

The PDP 10 mainly comprises a first substrate structure (rear unit) 201 and a second substrate structure (front unit) 202, which are a substrate structure pair of the front surface side and the rear surface side sandwiching discharge spaces. The display area 40 of the PDP 10 is made of columns of display cells (C). A set of the display cells (Cr, Cg, Cb) corresponding to each color of R (red), G (green), B (blue) in the first direction (x) forms a pixel (P).

The rear unit 201 includes a first glass substrate (rear glass substrate) 11, display electrodes (31, 32), a first dielectric layer 12, and a protective layer 13. A plurality of display electrodes (31, 32) are formed on the first glass substrate 11 (front side) extending in parallel in the first direction (x). The first dielectric layer 12 is formed on the first glass substrate 11 so as to cover the display electrodes (31, 32). Further, the protective layer 13 is formed on the side of a surface exposed in the discharge space on the first dielectric layer 12. The display electrodes (31, 32) comprise a sustain electrode (X) 31 for sustain drive and a scanning electrode (Y) 32 for sustain and scanning drive.

The front unit 202 includes a second glass substrate (front glass substrate) 21, an address electrode (A) 33, a second dielectric layer 22, a stripe barrier rib 23, and phosphor layers 24 {24r, 24g, 24b}. A plurality of address electrodes 33 are formed on the second glass substrate 21 (rear side) extending in parallel in the second direction (y) so as to cross the display electrodes (31, 32). The second dielectric layer 22 is formed so as to cover the address electrode 33 on the second glass substrate 21.

Further, in the present PDP 10, barrier ribs 23, phosphors (phosphor layers) 24, and the like are formed to the front unit 202 side. It is not limited to this and the barrier ribs 23 may be formed to, for example, the rear unit 201 side. The barrier ribs 23 are formed in stripes along the second direction (y) on the second dielectric layer 22 and between the address electrodes 33. Although the phosphor layers 24 {24r, 24g, and 24b} of respective colors of R, G, B are, between the barrier ribs 23 of the discharge space, formed on the surface of the second dielectric layer 22 corresponding to the address electrode 33 and on the side surfaces of the barrier rib 23, it is desirable that the phosphor layer is formed on the barrier rib side surface only.

The front unit 202 and the rear unit 201 are arranged so as to face each other, and a peripheral part of the substrate thereof are sealed by a seal glass and the like, and a discharge gas, for example, Ne—Xe gas is filled and encapsulated in the space compared by the barrier ribs 23, thereby to form the PDP 10.

In the PDP 10 of the above structure, when an electric field is applied between the display electrodes (31, 32) and the address electrode 33, the discharge gas is excited and ionized, so that vacuum ultraviolet ray is emitted. This emitted vacuum ultraviolet ray hits upon the phosphor layer 24, whereby the corresponding color of the visible light is emitted from the phosphor layer 24. This visible light is utilized for display at the display cell and recognized as luminance by a user. For example, the sustain discharge between the sustain electrode 31 and the scanning electrode 32, and an address discharge between the scanning electrode 32 and the address electrode 33 are generated.

Although not illustrated, other than the above-described PDP 10, the PDP device includes a driving circuit for driving an electrode group of the PDP 10 by applying a voltage and a control circuit for controlling the entirety including the driving circuit, thereby performing an image display to the PDP 10 by drive control of fields and subfields.

<Configuration Including Specular Reflecting Film>

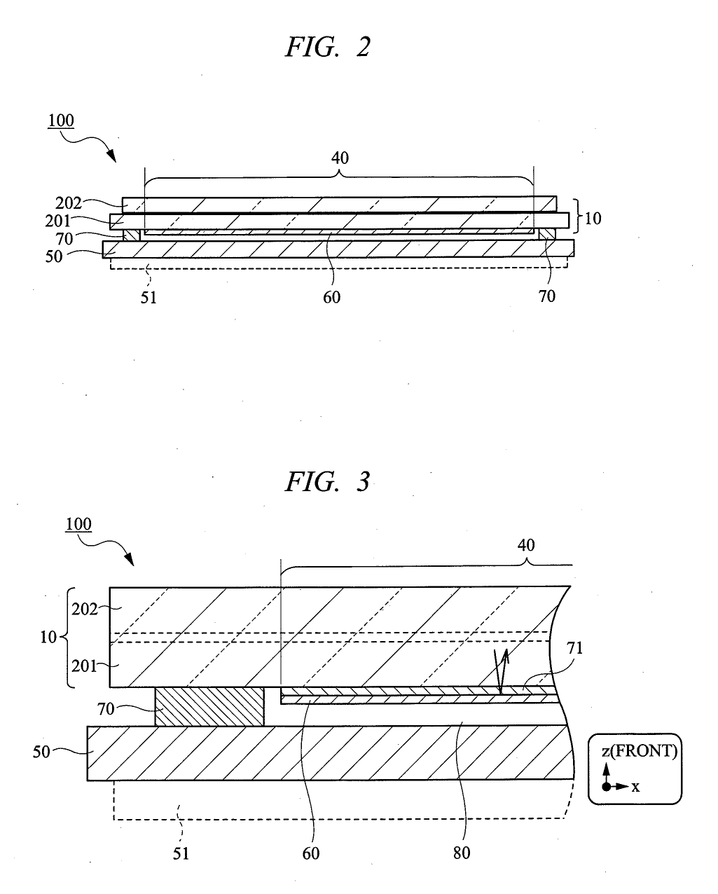

Next, FIG. 2 and FIG. 3 show the PDP 10 and the PDP module 100 of the first embodiment (configuration 1A) of the present invention. The PDP module 100 has the PDP (panel) 10 fixed to a chassis 50 by the rear surface side of the PDP 10. A mounting area 51 of the circuits such as a driving circuit, a control circuit, and a power supply circuit is provided to the rear surface side of the chassis 50. Note that, the details of the barrier rib 23 of the PDP 10, a region of a sealing portion, the chassis 50, and the mounting area of circuits and the like 51, and the connecting portion (FPC and the like) with an electrode of the PDP 10 and the circuit unit are omitted.

FIG. 2 shows a configuration in which the specular reflecting film 60 is fixed to the rear surface side of the rear unit 201 of the PDP 10 on the entire surface corresponding to the display area 40. The fixation or the formation of this specular reflecting film 60 is performed by, for example, adhesion or metal evaporation and coating of a reflecting material. With respect to the structure of the fixation of the PDP 10 and the chassis 50, in the rear surface side of the rear unit 201, for example, the peripheral part (frame part) including the peripheral part of the left, right, top and bottom of the panel is fixed by adhesion to the surface of the chassis 50 via the adhesive 70 such as a double-sided tape.

In FIG. 3, with respect to the configuration of the fixation of the specular reflecting film 60, for example, the rear surface of the rear unit 201 (first glass substrate 11) has the specular reflecting film 60 adhered thereto via an adhesive (adhesive layer) 71 having optical transmittance. As the specular reflecting film 60, for example, an Al sheet is used. Further, to the rear surface side of the specular reflecting film 60, an air space 80 is provided between the chassis 50 to prevent exfoliation of the specular reflecting film 60. For example, the configuration is made to have the thickness of the adhesive (double-sided tape and the like) 70 to be larger than the thickness of the specular reflecting film 60 and the adhesive (adhesive layer) 71 part.

<Cross Section>

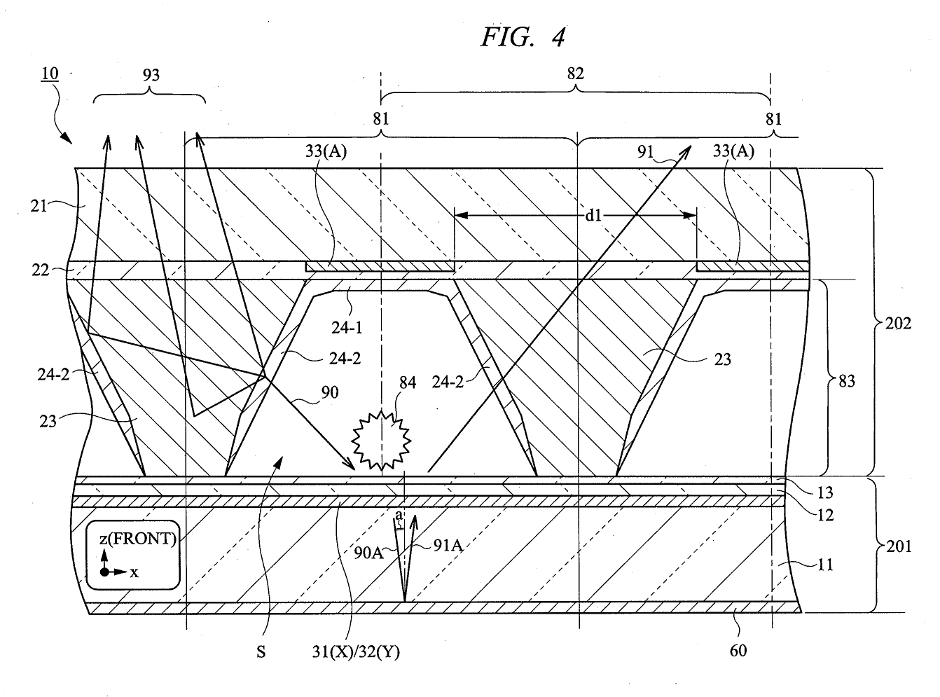

FIG. 4 shows a cross sectional structure (cross section of x-z) of the PDP of the first embodiment. In FIG. 4, a first unit emission area 81 corresponding to a single display cell (C) and a second unit emission area 82 serving as an area between the adjacent display cells (C) are shown. An area (area between substrates) 83 is different from the actual aspect ratio, and is shown larger than the substrates.

The first unit emission area 81 is an emission area in the center of the address electrode 33. The second unit emission area 82 is an emission area taken at the center of the barrier rib 23 between the address electrodes 33. An inter-substrate area (discharge space area) 83 is a discharge space (S), an area such as the barrier rib 23 and the like between the front unit 202 and the rear unit 201 (between the substrates). A sustain discharge position 84 shows a position of a sustain discharge between the sustain electrode (X) 31 and the scanning electrode (Y) 32. The sustain discharge position 84 is close to the rear unit 201 side, and a bottom unit 24-1 of the phosphor layer 24 is close to the front unit 202 side.

Note that, thicknesses of the first glass substrate 11 and the second glass substrate 21 are actually larger than the inter substrate area 83. While FIG. 4 shows a cross section at the display electrodes (31, 32) (for example, the bus electrode thereof), from another cross section at the center of the display cell (C), the display electrodes (31, 32) are not visible.

The address electrode 33 and the second dielectric layer 22 are formed to the rear surface of the second glass substrate 21 of the front unit 202. The translucent barrier rib 23 is formed to the front unit 202 by, for example, sandblast and the like. Between the barrier ribs 23, the phosphor layer 24 is formed by coating. The phosphor layer 24 includes the bottom unit 24-1 and a side unit 24-2. The bottom unit 24-1 is formed on a surface of the second dielectric layer 22 corresponding to the address electrode 33 on the front unit 202 side. The side unit 24-2 is formed on side surfaces of the barrier rib 23. A film-shaped filter and the like may be provided to the front most surface of the front unit 202.

The display electrodes (31, 32), the first dielectric layer 12, and the protective layer 13 to the front surface of the first glass substrate 11 of the rear unit 201. The specular reflecting film 60 is formed to the rear surface side of the first glass substrate 11, for example, on the entire surface (as a solid layer) as shown in FIG. 2.

In FIG. 4, the reference numerals 90, 91, 93, 90A, and 91A denote examples of light (light path) (expression of refraction and the like are partially omitted). The light paths 90 and 93 show a representative example of a pattern where light emitted from the phosphor layer (side unit) 24-2 passes through the display surface side. The former (90) is light emitted from the phosphor layer (side unit) 24-2 to the discharge space (S) side, and the latter (93) is light emitted from the phosphor layer (side unit) 24-2 to the barrier rib 23 side.

The present configuration includes a measure to effectively take out the light emission from the phosphor layer 24, particularly, the light emission from the phosphor layer (side unit) 24-2 of the side surface of the barrier rib 23.

The thickness of the phosphor layer (side unit) 24-2 is decided such that an omnidirectional total emission amount is close to the maximum and the transmittance of the film is high. The thickness thereof, though is slightly changed depending on the particle size of the phosphor, is preferable to be about 5 to 10 microns.

The light 93 emitted from the phosphor layer (side unit) 24-2 to the barrier rib 23 side is directly emitted to the display surface side by the transmittance of the barrier rib 23 or is reflected by the surface of the opposite side of the barrier rib 23 and emitted to the display surface side. Here, what is important is that the barrier rib 23 is made translucent by slightly putting a filler (such as alumina, or titania) having light diffusion property. As a result, the light emitted in the direction opposite to the display surface is diffused on the way, and is emitted to the display surface side.

The light 90 emitted from the phosphor layer (side unit) 24-2 to the discharge space (S) side is refracted upon incidence to the glass substrate 11 of the rear surface, and travels like the light 90A at an angle (elongation a) close to perpendicular. The light 90A is reflected by the specular reflecting film 60 of the rear surface so that it becomes light 91A, and this light returns to the original display cell and enters the discharge space (S), and is again refracted and transmits the phosphor layer (side unit) 24-2 and the barrier rib 23 as the light 91, thereby being emitted to the display surface side. Here, the width of the glass substrate 11 is 1.8 to 2.8 mm, which is much larger than a width (83) of the discharge space (S). Therefore, though it has been not considered that the light emitted from the cell returns to the original cell, it was found that the refraction between the discharge space (S) and the glass substrate 11 greatly helps the light return with high efficiency.

The display electrodes (31, 32) may be given light reflectivity toward the front surface side. For example, the metal which forms the display electrodes (31, 32) is given light reflectivity toward the front surface side. It is preferable to design the phosphor layer 24 to have predetermined transmittance.

<Planar Surface>

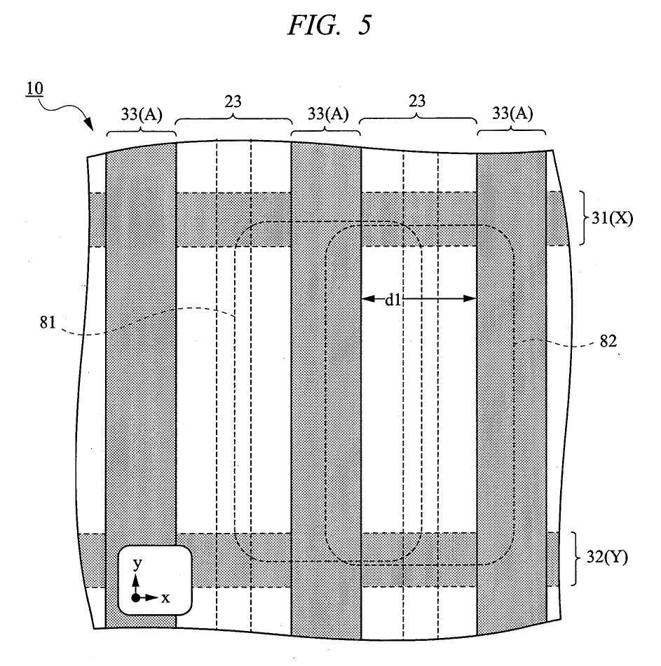

In FIG. 5, corresponding to FIG. 4, a planar structure of the display surface (front unit 202 side) of the PDP 10 is shown. A schematic arrangement structure of each electrode (31, 32, 33) and the barrier rib 23 and the like corresponding to the first unit emission area 81 and the second unit emission area 82 (corresponding area between the cells) is shown.

The address electrode 33, for example, is linear, and is made of metal. While the display electrodes (31, 32), for purpose of description, are shown as linear and metal bus electrodes only, they may include various shapes of transparent electrodes and auxiliary electrodes and the like.

When seen from the first unit emission area 81, the emission (for example, the visible light of R) of the display cell (C) comes out to the display surface side through the area of the bottom surface of each barrier rib 23 on both sides of the address electrode 33 area. Further, when seen from the second unit emission area 82, each emission (for example, visible lights of R and G) of the adjacent display cells (C) comes out to the display surface side through the area of the bottom surface (lateral width: d1) of the barrier rib 23 between the adjacent address electrode 33 areas.

Since the discharge emission mainly occurs at the front surface side via the translucent barrier rib 23, emission distribution in the display surface partially overlaps between the adjacent display cells similarly to the second unit emission area 82 (for example, mixing of the visible lights R and G).

<Effect of Specular reflecting Film>

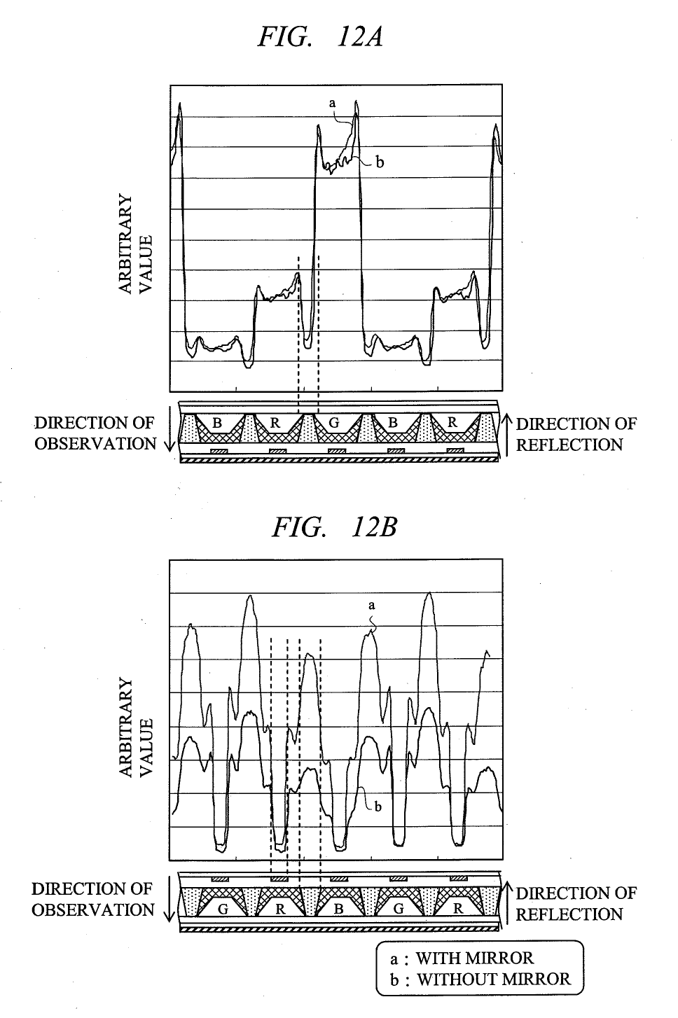

In FIG. 12, comparing with the conventional art, the effects (emission efficiency) and the like of the configuration of the first embodiment including the specular reflecting film 60 (and translucent barrier rib 23) will be described. In the PDP 10 of the first embodiment, an incidence angle “a” to the specular reflecting film 60 as the light path 91 of FIG. 4 becomes sufficiently small (closer to perpendicular) due to the refraction and the like in the area 83 of the discharge space (S). As a result, the discharge emission is effectively reflected on the front surface side and returns to the original display cell (first unit emission area 81). Therefore, together with the action of the translucent barrier rib 23, the emission efficiency in the transmission-type PDP is increased. In other words, an emission loss is reduced, thereby improving the contrast. Further details are as follows.

FIG. 12A shows an emission profile (experimental data example) observed from the panel front surface (display surface) side in the case where the mirror (having specular reflectivity) is arranged on the panel rear surface side (rear glass substrate side) in the conventional mainstream reflection-type PDP. An arrangement of respective display cells corresponding to respective colors of R, G, B of the phosphors is shown in the lateral direction. The luminance of the emission (arbitrary value and not absolute luminance) is shown in the longitudinal direction. In this manner, in the reflection-type PDP, regardless of the presence or absence of the mirror, the luminance of the emission does not change much, that is, the light reflection of the mirror does not contribute much to the luminance. Further, while the barrier rib is not given much transmittance, the phosphor emission does not enter much. Thus, the luminance in the area corresponding to the barrier rib becomes low.

FIG. 12B shows an emission profile (experimental data example) of emissions from the rear surface side of the panel (front surface side of the transmission-type PDP) in the case where the reflection-type PDP of FIG. 12A is reversely arranged (substantially corresponding to the configuration of the transmission-type PDP) and the front surface side of the panel (rear surface side of the transmission-type PDP) is arranged with the mirror. The “a” indicates the case where the mirror is provided, and the “b” shows the case where the mirror is not provided. As shown, in the reversal arrangement of the reflection-type PDP (transmission-type PDP), the case of “a” where the mirror is provided has improved emission luminance as compared with the case of “b” where the mirror is not provided, that is, the reflection of the light by the mirror contributes to the luminance. In the area which includes a barrier-rib-corresponding area between the address electrodes except an address-electrode-corresponding area, as against the shape (shape having three crests) of the profile of the original luminance like “b”, the luminance is high with the shape basically remaining the same like the “a”. Moreover, by making the film thickness thinner and increasing the light-transmittivity of the phosphor, the luminance is further improved.

In the case of the configuration of FIG. 12B, in the address-electrode-corresponding area, the light is shut out, and the luminance is reduced, while the luminance is increased other area than that in the area between the address electrodes. Hence, the display cell (unit emission area) is positioned between the display cells against the conventional reflection-type PDP. That is, for example, in the area conventionally between the cells of R and G, and between the address electrodes, the adjacent light emissions of R and G are visible as being mixed. If going by the configuration of the first embodiment, this corresponds to the second unit emission area 82 of FIG. 5.

In the case of the reflection-type PDP of FIG. 12A, the reason why the luminance does not change much by the presence or absence of the mirror is considered to be the following reason. Among the discharge emissions (emissions from the bottom part of the phosphor on the rear unit side), even when the light toward the rear surface direction is reflected by the mirror via the rear surface glass substrate (thickness is generally larger than other areas), since the incidence angle to the mirror is relatively large because of the structure, the reflected light does not return much to the front surface side, and therefore, this does not contribute much to the display luminance. The reason why the incidence angle is large is because, for example, among the light emissions from the bottom surface of the phosphor to the rear surface side, the angle of the components toward directions other than the address electrode direction is large, and the like.

On the other hand, in the case of FIG. 12B (the case of the first embodiment and the like), among the discharge emissions (light emissions from the bottom unit 24-1 of the phosphor layer 24), when the light toward the rear surface direction is reflected by the mirror (specular reflecting film 60), the incidence angle (example: FIG. 4A) to the mirror is relatively small because of the structure, and therefore, the reflection light returns much to the front surface side, and this greatly contributes to the display luminance. The reason why the incidence angle is small is, for example, because it is considered that the light emission from the bottom unit of the phosphor layer to the rear surface side is refracted upon passing through the discharge space and the rear unit 201, so that the incidence angle of the light arriving at the mirror becomes small and the like.

### Second Embodiment

### Configuration 1Ba

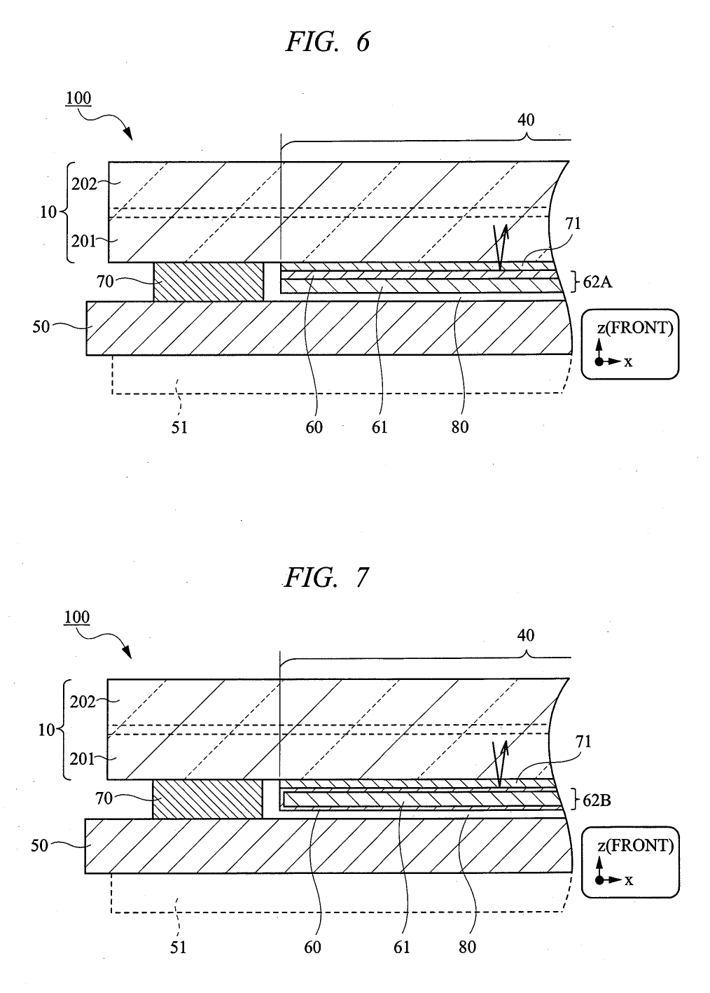

Next, FIG. 6 shows the PDP 10 and the PDP module 100 of a second embodiment (Configuration 1Ba) of the present invention. This is configured such that the rear surface side of a rear unit 201 is fixed with a member 62A having specular reflectivity and heat transfer property (thermal conductivity). More specifically, the configuration is such that the rear surface of a first glass substrate 11 is adhered with a member 62A made of a specular reflecting film (specular reflecting member) 60 such as an Al sheet via the adhesive (adhesive layer) 71 and a heat transfer member 61 such as a carbon sheet on the entire surface corresponding to the display area 40. Between the heat transfer member 61 and the surface of the chassis 50, there is the air space 80. The heat from the PDP 10 is transferred to the chassis 50 side via the adhesive 70 such as a double-sided tape, and is dissipated. Further, the heat is transferred from the rear unit 201 to the member 62A, and is dissipated by the heat transfer member 61.

### Third Embodiment

### Configuration 1Bb

FIG. 7 shows the PDP 10 and the PDP module 100 of a third embodiment (configuration 1Bb) of the present invention. This is an example using the heat transfer member 61 similarly to the second embodiment. The configuration is such that the rear surface side of the first glass substrate 11 is adhered with a member 62B which is formed by coating the heat transfer member 61 such as a carbon sheet by the specular reflecting film (specular reflecting member) 60 such as an Al resin via the adhesive (adhesive layer) 71 on the entire surface corresponding to the display area 40. Between the member 62B and the surface of the chassis 50, there is the air space 80. The heat is transferred from the rear unit 201 to the member 62B, and is dissipated by the heat transfer member 61.

### Fourth Embodiment

### Configuration 1C

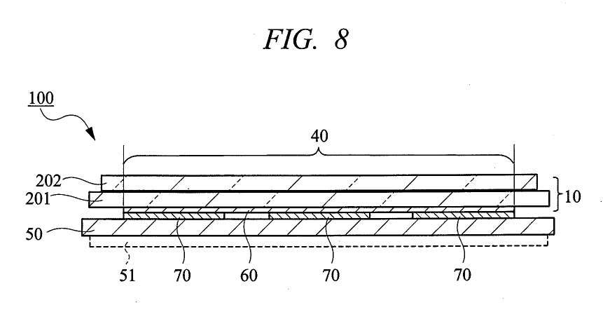

FIG. 8 shows the PDP 10 and the PDP module 100 of a fourth embodiment (configuration 1C) of the present invention. This is configured such that a specular reflecting film 60 is formed on the rear surface side of the rear unit 201 of the PDP 10, for example, on the entire surface corresponding to the display area 40, and moreover, the rear surface side of the specular reflecting film 60 and the surface of the chassis 50 are adhered by the adhesive 70 such as a double-sided tape. The adhesive 70 (double-sided tape and the like) can be, for example, fixed by dividing into a plurality of areas. The fourth embodiment (configuration 1C) is a configuration having the specular reflecting film 60 added to the conventional configuration of the fixation of the PDP surface and the chassis surface by a double-sided tape and the like.

### Fifth Embodiment

### Configuration 2A

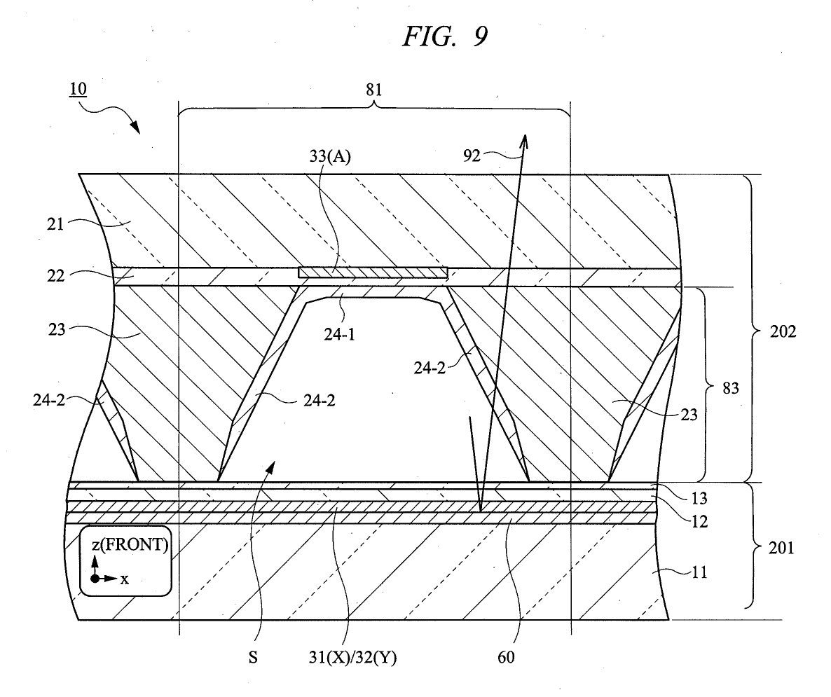

Next, in FIG. 9, the PDP 10 of a fifth embodiment (configuration 2A) of the present invention will be described. In the fifth embodiment, different from the first embodiment (configuration 1A) and the like, the front surface side (inside of a rear unit 201) is configured to have the specular reflecting film (specular reflecting layer) 60 formed and arranged on the first glass substrate 11 of the rear unit 201.

FIG. 9 shows a cross sectional structure (x-z plane) of the PDP 10 of the fifth embodiment, and also shows the first unit emission area 81. The specular reflecting film 60 is formed on the front surface side of the first glass substrate 11 of the rear unit 201, for example, on the entire surface corresponding to the display area 40 at a position of the height below the forming surface of the display electrodes (31, 32). Above the specular reflecting film 60, the display electrodes (31, 32) and the first dielectric layer 12 and the like are formed. The light emission from the bottom unit 24-1 of the phosphor layer 24, for example, similarly to a light path 92, passes through the discharge space (S), a first dielectric layer 12 and the like, and is reflected by the specular reflecting film 60, and is transmitted by a barrier rib 23 and the like, and passes toward the front surface side. As a result, similarly to the first embodiment, the discharge emission is effectively returned to the front surface side, thereby increasing the luminance.

In the case of the fifth embodiment, as compared with the first embodiment, due to a difference of the arrangement of the specular reflecting film 60 to the front and rear surfaces of the first glass substrate 11, the distance between the front surface (protective layer 13) at the rear unit 201 and the specular reflecting film 60 becomes short, and the length in the light path including the specular reflecting film 60 becomes short.

Further, for example, the specular reflecting film 60 may be formed over the area except the display electrodes (31, 32) in the entire surface corresponding to the display area 40 and at the same layer as the forming surface of the display electrodes (31, 32). Alternatively, the specular reflecting film 60 may be formed not on the entire surface, but in the area including the vicinity of the center of the display cell.

### Sixth Embodiment

### Configuration 2Ba

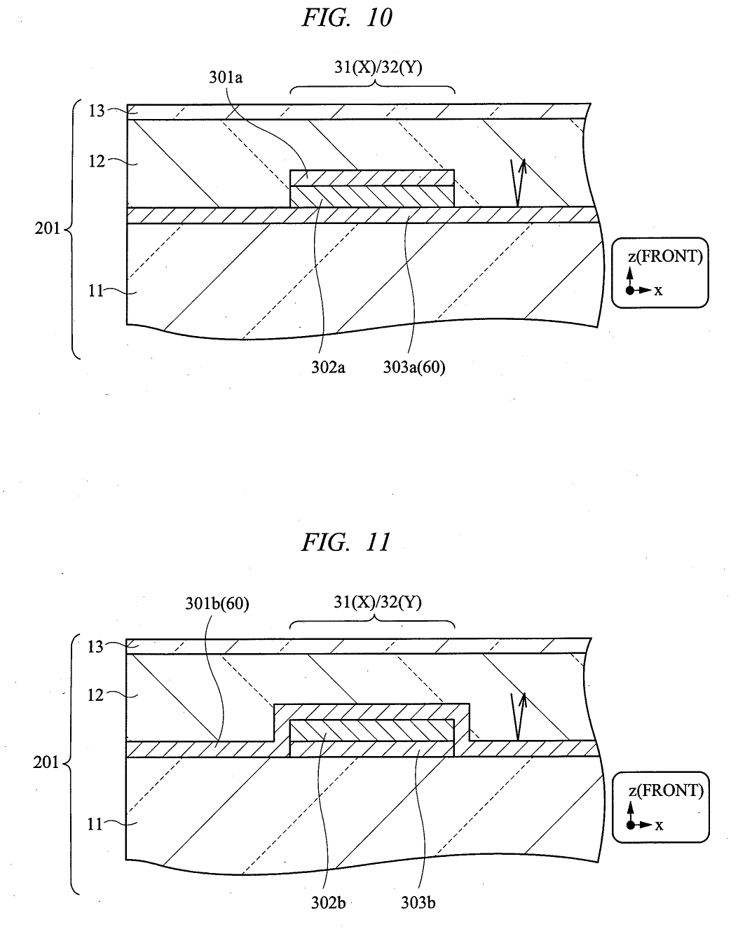

Next, FIG. 10 shows a PDP 10 of a sixth embodiment (configuration 2Ba) of the present invention. In the sixth embodiment (and a seventh embodiment), similarly to the fifth embodiment, the specular reflecting film (specular reflecting layer) 60 is formed to the front surface side of the first glass substrate 11 of the rear unit 201. More particularly, the specular reflecting film 60 is formed in common with a part of the layers of the display electrodes (31, 32).

The configuration of the display electrodes (31, 32) for the first glass substrate 11 is formed, for example, by a three-layer structure of Cr (upper layer Cr), Cu (intermediate layer Cu), and Cr (lower layer Cr). It utilizes Cr having specular reflectivity. In the sixth embodiment (configuration 2Ba), by using the lower layer Cr among these three-layers, the specular reflecting film 60 (specular reflective lower layer Cr 303a) is formed. In the area of the lower layer Cr (303a), the specular reflecting film 60 (specular reflective lower layer Cr 303a) is formed, for example, on the entire surface (solid layer) corresponding to the display area 40 or an area wider than at least the primary display electrode (intermediate layer Cu 302). The other two layers (upper layer Cr 301a and the intermediate layer Cu 302a) are conventionally taken as the forming portions of the primary electrode pattern. Each electrode (31, 32, 33), for example, is fabricated by sputtering and etching. Note that, other materials and processes may be employed. As a manufacturing method, for example, at the first stage, a specular reflective lower layer Cr 303a is formed on the first glass substrate 11, and at the second stage, the intermediate layer Cu 302 and the upper layer Cr 301a are formed.

### Seventh Embodiment

### Configuration 2Bb

FIG. 11 shows the PDP 10 of a seventh embodiment (configuration 2Bb) of the present invention. In the seventh embodiment, by using the upper layer Cr from among three-layers of display electrodes (31, 32), the specular reflecting film 60 (specular reflective upper layer Cr 301b) is formed.

In the area of the upper layer Cr (301b), for example, the specular reflecting film 60 (specular reflective upper layer Cr 301b) is formed, for example, on the entire surface (solid layer) corresponding to the display area 40 or an area wider than at least the display electrode (intermediate layer Cu 302b). The other two layers (the lower layer Cr 303b and the intermediate layer Cu 302) are conventionally taken as the forming portion of the primary electrode pattern. As a manufacturing process, for example, at the first stage, the lower layer Cr 303b and the intermediate layer Cu 302b are formed on the first glass substrate 11, and at the second stage, the specular reflective upper layer Cr 301b is formed.

In the case of the seventh embodiment, since the intermediate layer Cu 302b portion forming the electrode is covered by Cr (301b and 303b) in its periphery, a secondary effect is afforded that undesirable chemical reactions in the intermediate layer Cu 302b and the first dielectric layer 12 can be prevented.

### Other Configuration Examples

As another configuration examples, there is a configuration in which the specular reflecting film 60 is not provided on the entire surface corresponding to the display area 40 of the PDP, but the specular reflecting film 60 is not provided on a part of the entire surface so that it can be used for an aging test of the panel, that is, a through area (light-transmitting area) is provided. By using this through area, a test (test on a degree of the light element passing toward the rear surface side) on the light from the rear unit 201 side of the PDP 10 is made possible.

Alternatively, as another configuration example, the specular reflecting film (member) 60 of the rear surface side of the PDP 10 is not configured to be completely fixed so as to be used for the above test, but configured to be attachable/detachable when needed. In a state in which the specular reflecting film 60 is detached, the above test and the like are made possible. Alternatively, when the configuration is made such that the specular reflecting film 60 is completely fixed to the panel rear surface side so as not to be detachable (for example, the first embodiment), at the manufacturing time, before fixing (forming) the specular reflecting film 60, the panel rear surface side is tested by the same conventional method, and after that, the specular reflecting film 60 is fixed (formed), thereby finishing it as a product. In the case of such a configuration, a check can be securely made per a display cell, and a state of the protective layer 13 (MgO) can be confirmed by the aging test.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention is applicable to a PDP device.

What is claimed is:

1. A plasma display panel comprising a first and a second substrate structures sandwiching a discharge space for encapsulating a discharge gas, in which a cell group is configured by an electrode group,
wherein the first substrate structure includes a display electrode pair covered by a first dielectric layer and extending in a first direction to a first glass substrate,
wherein the second substrate structure includes an address electrode extending in a second direction to a second glass substrate,
wherein the first substrate structure is arranged on a rear surface side and the second substrate structure is arranged on a front surface side,
wherein the second substrate structure includes: a barrier rib formed thereon extending at least in the second direction so as to separate the discharge space; and
between the barrier ribs, phosphor layers of respective colors formed at least on a side surface of the barrier ribs and exposed in the discharge space,
wherein the barrier rib is translucent to the light emission from the phosphor layer, and
wherein a specular reflecting film or a member having specular reflectivity in a third direction perpendicular to the panel surface is provided to the first glass substrate in the first substrate structure side.

2. The plasma display panel according to claim 1,
wherein the specular reflecting film is fixed to the rear surface of the first glass substrate.

3. The plasma display panel according to claim 2,
wherein the specular reflecting film is adhered to the rear surface of the first glass substrate on the entire surface corresponding to a panel display area by an adhesive layer.

4. The plasma display panel according to claim 2,
wherein the panel is fixed to a chassis by an adhesive material by a peripheral part of the first substrate structure, and the specular reflecting film is adhered to the rear surface of the first glass substrate by an adhesive layer on the entire surface corresponding to a panel display area to the rear surface of the first glass substrate except the area fixed to the chassis, and an air space is provided between the specular reflecting film and the surface of the chassis.

5. The plasma display panel according to claim 2,
wherein a member formed of the specular reflecting film and a heat transfer member is adhered to the rear surface of the first glass substrate on the entire surface corresponding to a panel display area by an adhesive layer.

6. The plasma display panel according to claim 2,
wherein a member formed of a heat transfer member coated with the specular reflecting film is adhered to the rear surface of the first glass substrate on the entire surface corresponding to a panel display area by the adhesive layer.

7. The plasma display panel according to claim 1,
wherein the specular reflecting film is formed on the front surface side of the first glass substrate and in a plane area at a position below a forming surface of the display electrode.

8. The plasma display panel according to claim 7,
wherein the display electrode is formed by using three-layer structure of an upper layer Cr, an intermediate layer Cu, and a lower layer Cr on the first glass substrate in the first substrate structure, and
wherein the specular reflecting film is formed as a lower layer Cr having specular reflectivity on the entire surface corresponding to a panel display area or in the area at least having an area larger than that of the intermediate layer Cu of the display electrode in the area of the lower layer Cr of the display electrode.

9. The plasma display panel according to claim 7,
wherein the display electrode is formed by using the three-layer structure of an upper layer Cr, an intermediate layer Cu, and a lower layer Cr on the first glass substrate in the first substrate structure, and
wherein the specular reflecting film is formed as an upper layer Cr having specular reflectivity on the entire surface corresponding to the panel display area or in the area at least having an area larger than that of the intermediate layer Cu of the display electrode in an area of the upper layer Cr of the display electrode.

10. The display plasma panel according to claim 1,
wherein the display electrode has light reflectivity in the third direction to the light emission from the phosphor layer.
